(19) United States
(12) Patent Application Publication
(10) Pub. No.: US 2021/0248562 A1
(43) Pub. Date: Aug. 12, 2021

(54) METHOD AND SYSTEM FOR COMMUNICATING SOCIAL NETWORK SCHEDULING BETWEEN DEVICES

(71) Applicant: The Boeing Company, Chicago, IL (US)

(72) Inventors: John W. Glatfelter, Kennett Square, PA (US); Brian D. Laughlin, Wichita, KS (US)

(21) Appl. No.: 16/785,839

(22) Filed: Feb. 10, 2020

(51) Int. Cl. G06Q 10/10; G06Q 50/00; G06K 9/00

(52) U.S. Cl. CPC G06Q 10/1095; G06K 9/00288; G06Q 50/01

(57) ABSTRACT

A computer-implemented method includes determining, by a computer, whether an image depicts an individual that corresponds to a particular contact associated with a specific social networking goal specified in a goals database. The method further includes responsive to determining that the individual corresponds to the particular contact, retrieving from a contacts database a preferred communication mode and a preferred communication device associated with the particular contact. A meeting request communicated by the computer, to the particular contact via the preferred communication device using the preferred communication mode. The computer receives, and from the preferred communication device, an acceptance of the meeting request. The method also includes adding, by the computer, a record associated with the meeting request to a schedule database.

### BACKGROUND

### Field

This application generally relates to device communications. In particular, this application describes a method and system for communicating social network scheduling between devices.

### Description of Related Art

Social networking can be an invaluable tool in some professions. For example, an individual who is the sales-head for a company may attend conferences to meet potential buyers. In some cases, the sales-head will attempt to reach out to potential buyers to determine whether they will be attending a particular conference with the aim of running into the buyer during the conference.

However, some conferences can be quite large, which can, in some cases, make it more difficult to find the potential buyer. And in some cases, the buyer may be preoccupied with another event making contact with the buyer difficult.

### SUMMARY

In a first aspect, a computer-implemented method includes determining, by a computer, whether an image depicts an individual that corresponds to a particular contact associated with a specific social networking goal specified in a goals database. The method further includes, responsive to determining that the individual corresponds to the particular contact, retrieving from a contacts database a preferred communication mode and a preferred communication device associated with the particular contact. A meeting request is communicated by the computer to the particular contact via the preferred communication device using the preferred communication mode. The computer receives, from the preferred communication device, an acceptance of the meeting request. The method also includes adding, by the computer, a record associated with the meeting request to a schedule database.

In a second aspect, a system includes a memory and a processor. The memory stores instruction code. The processor is in communication with the memory. The instruction code is executable by the processor to cause the processor to perform operations that include determining whether an image depicts an individual that corresponds to a particular contact associated with a specific social networking goal specified in a goals database. Responsive to determining that the individual corresponds to the particular contact, the computer retrieves from a contacts database a preferred communication mode and a preferred communication device associated with the particular contact. The computer communicates a meeting request to the particular contact via the preferred communication device using the preferred communication mode. The computer receives from the preferred communication device, an acceptance of the meeting request, and adds a record associated with the meeting request to a schedule database.

In a third aspect, a non-transitory computer-readable medium having stored thereon instruction code is provided. When the instruction code is executed by a processor, the processor performs operations that include determining whether an image depicts an individual that corresponds to a particular contact associated with a specific social networking goal specified in a goals database. Responsive to determining that the individual corresponds to the particular contact, the processor retrieves from a contacts database a preferred communication mode and a preferred communication device associated with the particular contact. The processor communicates a meeting request to the particular contact via the preferred communication device using the preferred communication mode. The processor receives from the preferred communication device, an acceptance of the meeting request, and adds a record associated with the meeting request to a schedule database.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1 illustrates an environment that includes various systems/devices that facilitate social network scheduling, in accordance with an example.

FIG. 2 illustrates contact records that can be stored in a contacts database of a scheduling device of the environment, in accordance with an example.

FIG. 3 illustrates social networking records that can be stored in a goals database of the scheduling device, in accordance with an example.

FIG. 4 illustrates schedule records that can be stored in a schedules database of the scheduling device, in accordance with an example.

FIG. 5 illustrates user interfaces that can be generated by application logic of the scheduling device to facilitate scheduling a meeting with a user, in accordance with an example.

FIG. 6 illustrates operations performed by the scheduling device, in accordance with an example.

FIG. 7 illustrates a more detailed variation of the operations of FIG. 6, in accordance with an example.

FIG. 8 illustrates a computer system that can form part of or implement any of the systems or devices of the environment, in accordance with an example.

### DETAILED DESCRIPTION

Various examples of systems, devices, and/or methods are described herein. Words such as “example” and “exemplary” that may be used herein are understood to mean “serving as an example, instance, or illustration.” Any embodiment, implementation, and/or feature described herein as being an “example” or “exemplary” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Moreover, terms such as “substantially,” or “about” that may be used herein, are meant that the recited characteristic, parameter, or value need not be achieved exactly, but that deviations or variations, including, for example, tolerances, measurement error, measurement accuracy limitations and other factors known to skill in the art, may occur in amounts that do not preclude the effect the characteristic was intended to provide.

### I. Introduction

As noted above, it can be difficult in some cases to network with individuals in certain settings. These problems are overcome by the examples described below. In the examples, a scheduling system can scan a room full of individuals and identify potential contacts. The scheduling system can determine one or more preferred modes of communication with the contacts. The scheduling system can communicate an invitation to the contacts for a meeting via the preferred communication mode.

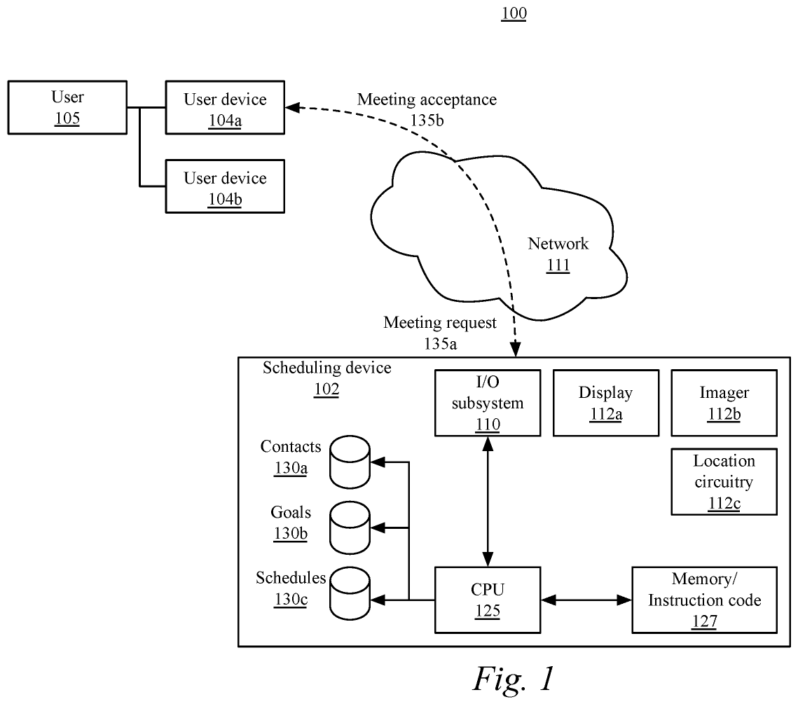

FIG. 1 illustrates an example of an environment 100 that includes various systems/devices that facilitate social network scheduling. Example systems/devices of the environment 100 include a scheduling device 102, a first user device 104a, and a second user device 104. The various entities of the environment 100 can be configured to communicate with one another via a network 111, such as the Internet.

An example of the scheduling device 102 can correspond to a computer, mobile device, tablet, smartwatch, and/or any other device that facilitates user interactions. The scheduling device 102 can include a memory 127 and a processor 125. The scheduling device 102 can include other subsystems. Within examples, these subsystems can include an input/output (I/O) subsystem 110, a display 112a, an imager 112b, location circuitry 112c, a contacts database 130a, a goals database 130b, and a schedules database 130c. Details related to the various subsystems of the scheduling device 102 and the operations performed by these subsystems are described in further detail below.

The processor 125 is in communication with the memory 127. The processor 125 is configured to execute instruction code stored in the memory 127. The instruction code facilitates performing, by the scheduling device 102, various operations that facilitate social network scheduling. In this regard, the instruction code can cause the processor 125 to control and coordinate various activities performed by the different subsystems of the scheduling device 102. The processor 125 can correspond to a stand-alone computer system such as an Intel®, AMD®, or PowerPC® based computer system or a different computer system and can include application-specific computer systems. The computer system can include an operating system, such as Microsoft Windows®, Linux, Unix®, Apple IOS®, Android®, or a different operating system.

An example of the I/O subsystem 110 can include one or more input, output, or input/output interfaces and is configured to facilitate communications with entities outside of the scheduling device 102. In this regard, an example of the I/O subsystem 110 can be configured to dynamically determine the communication methodology utilized by entities of the environment 100 and can communicate information to the entities with an interface that uses a determined communication methodology. For example, the I/O subsystem 110 can determine that a first entity utilizes a RESTful API and can, therefore, communicate with the entity using an interface that uses a RESTful communication methodology.

An example of the I/O subsystem 110 can include a wireless interface that facilitates wirelessly communicating with entities of the environment 100. Within examples, the wireless interface can include an 802.11 based interface, a cellular interface, a near field communication interface, and/or a different type of wireless interface. The cellular interface can be configured to implement various cellular telephone standards such a 3G, 4G, LTE, 5G, etc. It is contemplated that the cellular telephone standard could include and/or implement a yet to be developed wireless standard for communicating information between devices.

An example of the imager 112b can capture a still image or live image of a scene near the scheduling device 102. An example of the imager 112b can correspond to a charge-coupled device that captures a bitmap image of the scene, such as a camera. Other examples of imager can correspond to and/or incorporate functions such as smart auto-focus circuitry, infrared (IR) laser circuitry, light detection and ranging (LIDAR) circuitry, etc. The imager 112b can include or work in cooperation with the processor 125 to identify particular images within the scene. The images can correspond to faces of individuals within a scene. In this regard, the imager 112b and/or the processor 125 can implement various supervised and unsupervised machine learning models that can facilitate facial recognition of images within the scene. The machine learning logic can be based on algorithms such as a Holt-Winters algorithm, an exponential time smoothing (ETS) algorithm, an artificial neural network (ANN), a recurrent neural network (RNN), a seasonal autoregressive moving average (SARIMA) algorithm, a network of long short-term memories (LSTM), a gated recurring unit (GRU) algorithm.

An example of the display 112a can correspond to a liquid crystal display (LCD), a light emitting diode (LED) display, or a different type of display. An example of the display 112 can correspond to a touch-screen display 112a that facilitates touch-based interactions with the scheduling device. In this regard, an example of the scheduling device 102 can depict a graphical user interface (GUI). The GUI can depict various controls that facilitate user interaction with the scheduling device 102. Within examples, the GUI can display an image control that facilitates depicting the scene captured by the imager 112b. The GUI can depict overlays 515 over the scene to emphasize certain portions of the scene. For example, the GUI can depict one or more overlays 515 over images within the scene that correspond to faces. The GUI can depict buttons, input boxes, list boxes, etc. that facilitate performing additional operations of the scheduling device 102 that are described in further detail below.

An example of the location circuitry 112c can correspond to circuitry, such as global positioning system circuitry (GPS circuitry) configured to determine the geographic location of the scheduling device 102. In this regard, the location circuitry 112c can operate in conjunction with the I/O subsystem 110 and an application operating on the scheduling device 102 to determine a physical address associated with the scheduling device 102. An example of the physical address can correspond to a street address. Another example of the physical address can correspond to a place of business, such as a hotel, conference center, a specific section of a large building, etc.

It is contemplated that any of the subsystems referenced herein can correspond to a stand-alone computer system such as an Intel®, AMD®, or PowerPC® based computer system or a different computer system and can include application-specific computer systems. The computer systems can include an operating system, such as Microsoft Windows®, Linux, Unix®, or another operating system. It is also contemplated that operations performed on the various subsystems can be combined into a fewer or greater number of subsystems to facilitate speed scaling, cost reductions, etc.

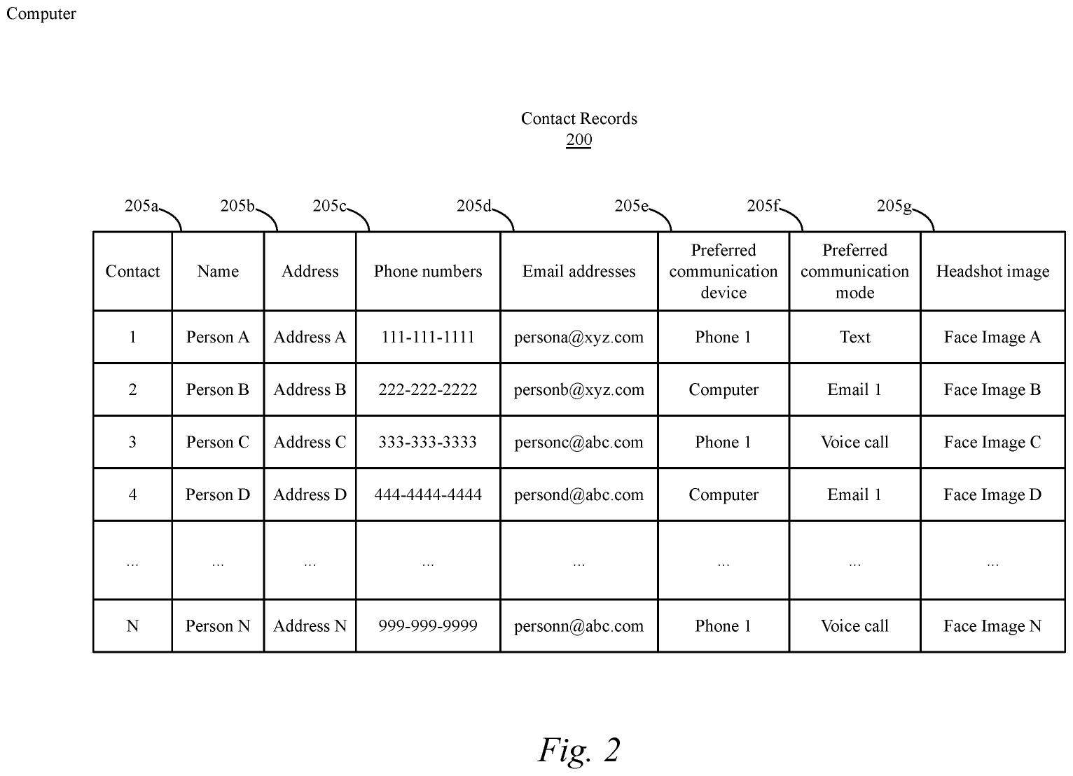

An example of the contacts database 130a can include contact records 200. FIG. 2 illustrates examples of contact records 200 that can be stored in the contacts database 130a. Within examples, fields 205 of each contact record 200 can specify a name 205a, an address 205b, one or more phone numbers 205c, one or more email addresses 205d, a preferred communication device 205e, a preferred communication mode 205f, and a headshot image 205g. Other information can be specified in the contact records 200.

The name 205a and address 205b can correspond to the name and address associated with a contact. The phone numbers 205c and email addresses 205d can correspond to phone numbers and email addresses associated with the contact. Within examples, these can include a home phone number, a work phone number, a cellphone number, a home email address, and a work email address. The headshot image 205g can specify an image associated with a contact, such as a headshot of the contact. For example, the image can correspond to a bitmap representation of the face of the contact.

The preferred communication device 205e and the preferred communication mode 205f can specify the preferred communication device and the preferred communication mode the contact prefers to use. In some examples, the preferred communication device 205e and the preferred communication mode 205f can be dynamically updated. For example, a user 105 associated with a particular contact record can, via a user device 104, communicate information to the scheduling device 102 to update the preferred communication device 205e and/or the preferred communication mode 205f specified in the contact record to specify the preferred communication device and the communication mode. In some examples, the user device 104 can automatically specify preferred communication devices and modes according to one or more rules. For example, the user device 104 can determine that the user 105 is at work and specify, to the scheduling device 102, the preferred communication mode to be the user's work email. In another example, the user device 104 can determine that the user 105 is driving and specify, to the scheduling device 102, the preferred communication device and the preferred communication mode to be “do not disturb” to indicate no communication device/mode is preferred.

In some examples, each contact record 200 can include one or more fields that specify interrupt priorities. The interrupt priorities can specify the conditions or reasons under which the contact is willing to be interrupted or not interrupted as the case may be. For example, the interrupt priorities can specify that a particular contact wants to be interrupted for reasons related to medical, travel changes, family updates, etc. The interrupt priorities can specify that the contact does not want to be interrupted for more trivial reasons.

In some examples, each contact record 200 can include one or more fields that specify whether the scheduling device 102 should make networking attempts. For example, certain contacts may be whitelisted to indicate attempts should be made and others may be blacklisted to indicate networking attempts should not be made.

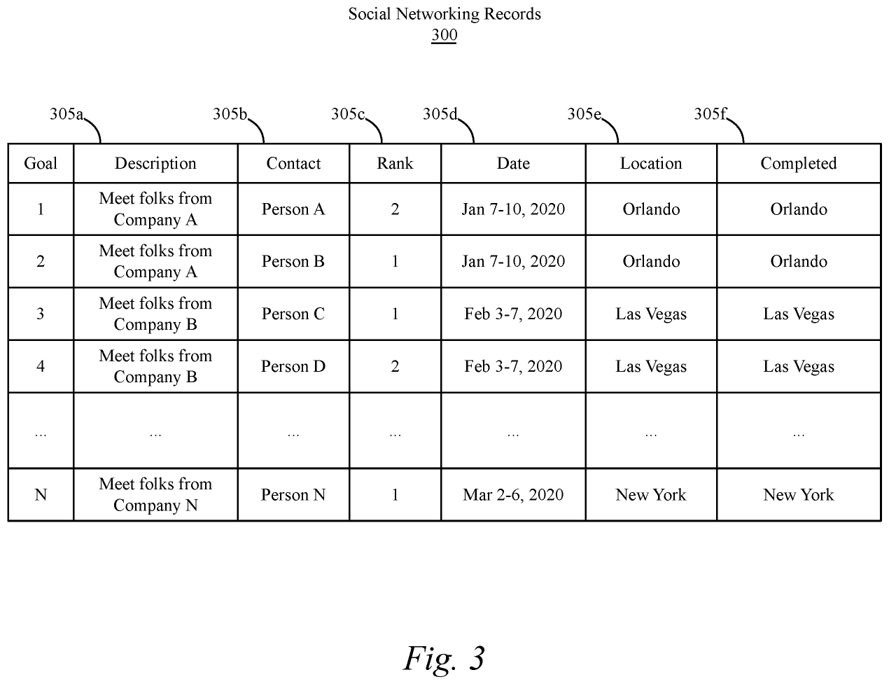

An example of the goals database 130b can include social networking records 300. FIG. 3 illustrates examples of social networking records 300 that can be stored in the goals database 130b. Each social networking record 300 can be associated with a particular social networking goal of the operator of the scheduling device 102, such as the desire to network with another person. In this regard, each record can specify information that facilitates arranging a networking meeting with the other person to thereby help the operator of the scheduling device 102 achieve a particular goal. Within examples, fields 305 of each social networking record 300 can specify a description 305a, a contact name 305b, a rank 305c, a date 305d, a location 305e, and a completion status 305f. Other information can be specified in the social networking records 300.

The description 305a can correspond to a generic description for the social networking goal and can facilitate grouping together different social networking records related to the same description 305a. The contact name 305b can correspond to the name of a particular person with which an operator of the scheduling device 102 desires a networking relationship. The person can be associated with a record in the contacts database 130a.

The rank 305c can be used to control an order in which requests for networking relationships are established. This is described in more detail below.

The date 305d and location 305e can correspond to the date and location at which the operator of the scheduling device 102 desires to establish the networking relationship with the person. The completion status 305f can specify whether a networking relationship with the person has been attempted and/or whether the networking relation has been established. Within examples, the completion status can specify that an attempt to network with the person has been made, accepted, or declined.

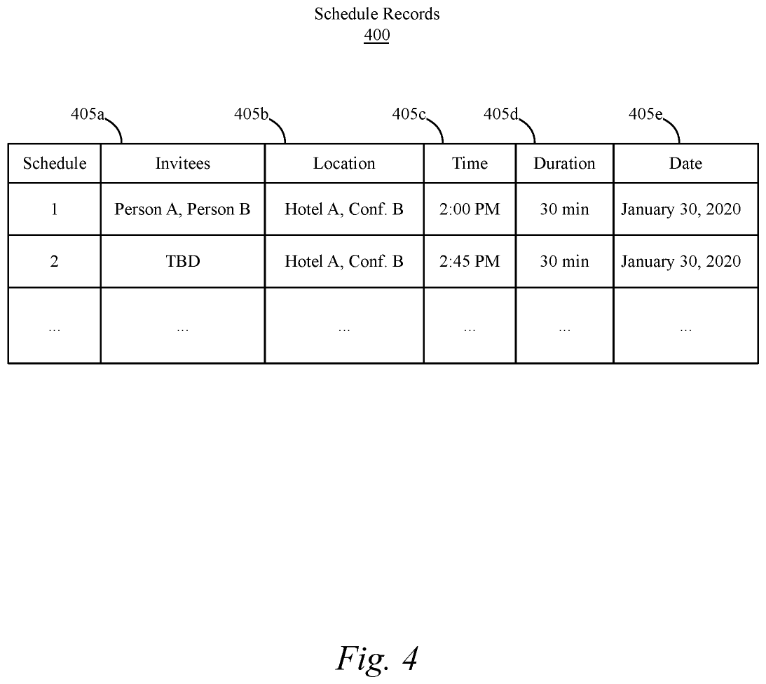

An example of the schedules database 130c can include schedule records 400. FIG. 4 illustrates examples of schedules records 400 that can be stored in the schedules database 130c. Within examples, fields 405 of each schedule record 400 can specify invitees 405a, a location 405b, a time 405c, a duration 405d, and a date 405e. Other information can be specified in the schedule records 400.

The invitees 405a can correspond to a list of one or more names associated with contacts expected to be attending a particular meeting. The location, time, duration, and date can specify the corresponding location 405b, time 405c, duration 405d, and date 405e associated with the meeting.

Examples of the user devices 104 can correspond to computers, mobile devices, tablets, and/or any other devices that facilitate communications with the scheduling device 102. In some examples, one or both of the user devices 104 can implement one or more aspects of the scheduling device 102. The user devices 104 for a particular user 105 can be different types of communication devices that facilitate communicating information in different ways. For example, the first user device 104a can be a smartwatch that facilitates discretely communicating text messages. The second user device 104b can correspond to a mobile device that facilitates receiving voice calls. When the user 105 is in a meeting, the user 105 may prefer to use the smartwatch for communications to avoid interrupting the meeting. In a different setting, the user 105 may prefer to use the mobile device for voice communications.

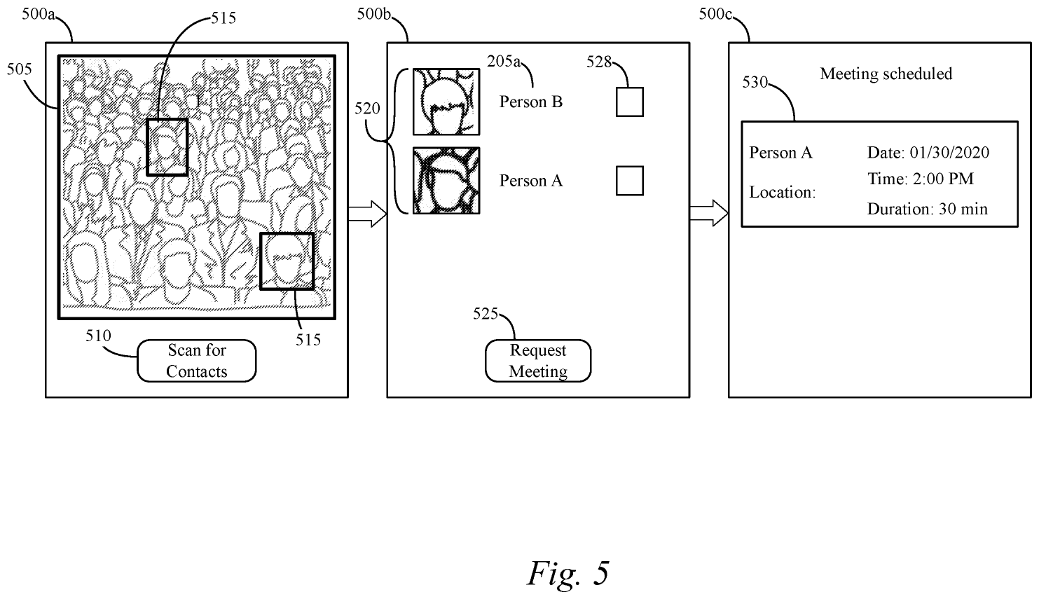

FIG. 5 illustrates examples of user interfaces (500a, 500b, and 500c) that can be generated by application logic of the scheduling device 102 to facilitate scheduling a meeting with the user 105. Referring to FIG. 5, an example of the first user interface 500a can include a scene control 505 and scan control 510. The scene control 505 can depict a scene provided by the imager 112b. An example of the scene can depict a group of individuals at a conference. The scene can be static or live (i.e., a video).

Responsive to actuation of the scan control 510, the application logic can cause one or more overlays 515 to be depicted over the scene. The overlays 515 can emphasize particular images of the scene. For example, the overlays 515 can have the shape of a box, oval, circle, or a different shape and can be centered around the faces or other identifying characteristics of individuals depicted within the image. The overlays 515 can emphasize images within the scene associated with faces. In this regard, as noted above, various machine learning models implemented by the imager 112b and/or the processor 125 can facilitate performing facial image recognition.

The emphasized faces can be associated with different contacts specified in the contacts database 130a related to a particular social networking goal specified in the goals database 130b. For example, the application logic can determine the date and location of the scheduling device 102 via the subsystems of the scheduling device 102. The application logic can search the goals database 130b for particular social networking records 300 that match the determined date and location. The application logic can then search the contacts database 130a for contact records 200 that match the contacts specified in these social networking records. The application logic can perform facial image recognition on the scene to locate images of the scene associated with the headshot images 205g. The application logic can then depict overlays 515 over the located images in the scene.

A second user interface 500b can depict thumbnails 520 that depict the different images identified above and/or that depict the headshot images 205g associated with the contacts determined above. In some examples, the names 205a associated with these contacts and a selection control 528 can be depicted adjacent to the thumbnails 520. In examples where multiple contacts are identified within the scene control 505, the thumbnails 520 associated with the contacts can be arranged according to the value of the rank 305c specified in the goals database 130b. For example, the rank 305c associated with Person B (i.e., 1) is higher than the rank 305c associated with Person A (i.e., 2). Therefore, Person B is listed before Person A. In some examples, the rank 305c can be dynamically adjusted/specified based on communication priorities and/or action-item list associated with the operator.

In operation, an operator of the scheduling device 102 can send an invitation to one or more of the listed contacts for a meeting by selecting, via the selection control 528, one or more of the contacts and selecting a meeting request control 525. The application logic can then communicate an invitation to the meeting to each of the selected contacts.

The application logic can determine the preferred communication device and the preferred communication mode associated with each selected contact and communicate the invitation to each contact via the preferred communication device and via the preferred communication mode. For example, the application logic can determine that Person A prefers a text message to his phone (i.e., Phone 1), whereas Person B prefers an email to his computer. In this case, the application logic can communicate the invitation to Person A via a text message to his phone and can send an email to Person B.

In some examples, a particular contact can be required to accept the meeting before an invitation to a second contact for the same meeting is sent. For example, in the illustrated example, Person B, who may be a vice president, may have to accept the invitation before the application logic will send the invitation to Person A, who may be a subordinate of Person B.

In some examples, the invitation can specify details such as the location, date, and time of the meeting. In this case, the application logic can search the schedules database 130c for a schedule record associated with an available timeslot for the meeting. In this regard, the operator of the scheduling device 102 may have prepopulated the schedules database 130c with potential timeslots. The application logic can select a timeslot most closely associated with the current location of the scheduling device 102 and the current time. For example, the application logic can used subsystems of the scheduling device 102 to determine that the scheduling device 102 is located near Hotel A and that the time is 9:00 AM. In this case, the application logic can select the first schedule record because the location matches the location of the scheduling device 102, and the time is a few hours after the current time.

In some examples, the scheduling device 102 can request a location, date, and time for the meeting from one or more of the selected contacts and subsequently specify this location, date, and time for the meeting.

A third user interface 500c can be depicted to indicate meeting details 530 associated with the accepted meeting. Within examples, the details can specify invitees that accepted the meeting. The details can specify the location, date, time, and duration of the meeting.

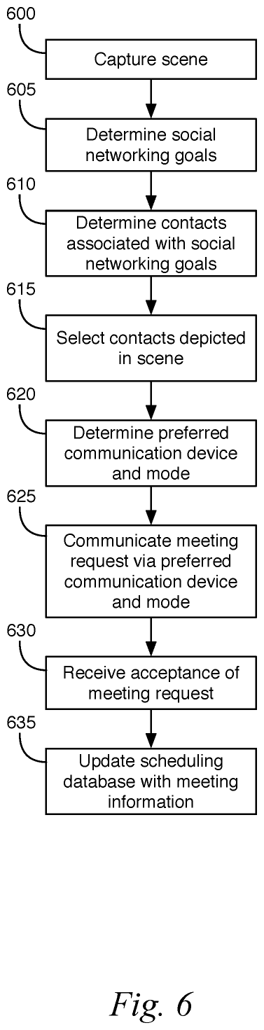

FIG. 6 illustrates examples of operations performed by the scheduling device 102. In this regard, one or more of the operations can be implemented via instruction code, stored in the memory 127 of the scheduling device 102, configured to cause the processor 125 of the scheduling device 102 to perform the operations illustrated in the figures and discussed herein.

At operation 600, the scheduling device 102 can capture a scene. For example, the operator of the scheduling device 102 can launch the application logic described above. The application logic can activate the imager 112b of the scheduling device 102, which can, in turn, communicate a scene to the display 112a of the scheduling device 102.

At operation 605, social networking goals 300 can be determined. For example, the application logic can determine the current date and location associated with the scheduling device 102 via the subsystems of the scheduling device 102. The application logic can search the goals database 130b for particular social networking records 300 that match the determined date and location.

At operation 610, contacts associated with the social networking goals 300 can be determined. For example, the application logic can search the contacts database 130a for contact records 200 that match contact names 305b associated with the social networking records 300.

At operation 615, contacts determined above that are depicted in the scene can be selected. For example, the application logic can utilize facial image recognition algorithms of machine learning models implemented by the scheduling device 102 to search the scene for images related to the headshot images 205g associated with the contact records 200. An example of the application logic can depict overlays 515 over the images to emphasize these portions of the scene 505 and/or thumbnail images 520 that depict the images. One or more of the contacts can be selected. For example, an operator of the scheduling device 102 can, via the display 112a, select the overlays 515 and/or the thumbnail images 520 to thereby select particular contacts.

At operation 620, the preferred communication device 205e and the preferred communication mode 205f for the selected contacts can be determined. For example, the application logic can search the contacts database 130a to determine the preferred communication device 205e and the preferred communication mode 205f associated with the selected contacts.

At operation 625, a meeting request 135a can be communicated to the selected contacts via the preferred communication device and the preferred communication device mode associated with the selected contacts.

At operation 630, an acceptance 135b of the meeting request 135a can be received from one or more of the contacts.

At operation 635, the application logic can update the scheduling database and indicate the contacts that have accepted the meeting request 135a.

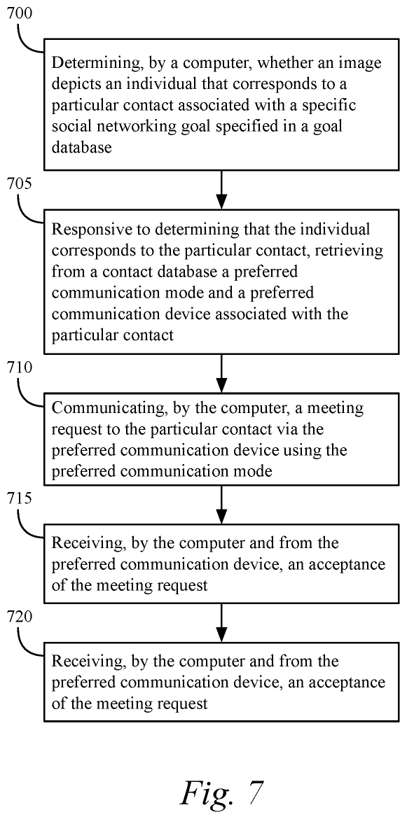

FIG. 7 illustrates a more detailed variation of FIG. 6. Block 700 can involve determining, by a computer, whether an image depicts an individual that corresponds to a particular contact associated with a specific social networking goal 300 specified in a goal database 130b.

Block 705 can involve, responsive to determining that the individual corresponds to the particular contact, retrieving from a contacts database 130a a preferred communication device 205e and the preferred communication mode 205f associated with the particular contact.

Block 710 can involve communicating, by the computer, a meeting request 135a to the particular contact via the preferred communication device 205e and the preferred communication mode 205f.

Block 715 can involve receiving, by the computer and from the preferred communication device, an acceptance 135b of the meeting request 135a.

Block 720 can involve adding, by the computer, a record associated with the meeting request 135a to a schedule database 130c.

In some examples, the computer corresponds to a portable device 102 that includes an imager 112b. These examples can involve receiving the image from the imager 112b of the portable device 102.

In some examples, the portable device 102 includes a display 112a. These examples can involve depicting the image and an overlay 515 on the display 112a of the portable device 102 to indicate a location within the image of the particular contact.

Some examples can involve depicting identifying information associated with the particular contact on the display 112a of the portable device 102.

Some examples can involve selecting, by the computer, one or more social networking goals 300 from the goals database 130b associated with a date range 305d that overlaps a current date, where the specific social networking goal 300 corresponds to one of the one or more social networking goals 300.

Some examples can involve determining, by the computer, a geographic location associated with the image, and selecting, by the computer, one or more social networking goals 300 from the goals database 130b associated with one or more locations 305e in proximity to the geographic location, where the specific social networking goal 300 corresponds to one of the one or more social networking goals 300.

In some examples, the computer includes location circuitry 112c configured to provide a geographic location of the computer. In these examples, determining the geographic location associated with the image can involve obtaining, by the computer, the geographic location from the location circuitry 112c of the computer.

Some examples can involve, responsive to communicating the meeting request 135a to the particular contact, updating, by the computer, a record in the goals database 130b associated with the specific social networking goal 300 to indicate communication with the particular contact has been attempted.

Some examples can involve determining, by the computer, that the image depicts a plurality of individuals that correspond to a plurality of contacts associated with a plurality of social networking goals 300 specified in the goals database 130b, where the plurality of social networking goals 300 specify a rank 305c. These examples can further involve communicating, by the computer, a first meeting request 135a to a first contact of the plurality of contacts associated with a first social networking goal 300 having a highest rank 305c via a preferred communication device 205e and a preferred communication mode 205f associated with the first contact; and subsequent to receiving an acceptance 135b of the first meeting request 135a and the adding of a first record associated with the first meeting request 135a to the schedule database, communicating, by the computer, a second meeting request 135a to a second contact associated with a second social networking goal 300 having a next highest rank 305c via a preferred communication device 205e and a preferred communication mode 205f associated with the second contact.

In some examples, communicating the meeting request 135a to the preferred communication device can involve obtaining, by the computer, from the schedules database an available time slot, and embedding, by the computer, information in the meeting request 135a that defines the available time slot.

In some examples, retrieving from the contacts database 130a the preferred communication mode 205f associated with the particular contact can involve communicating, by the computer and to the preferred communication device, a request for the preferred communication device to provide the preferred communication mode; and receiving, by the computer and from the preferred communication device, the preferred communication mode.

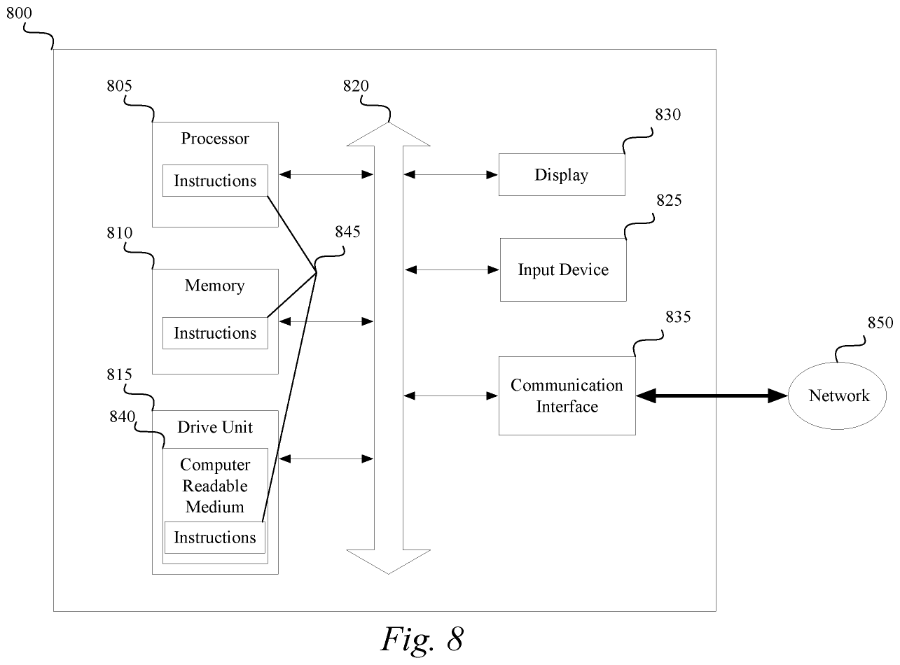

FIG. 8 illustrates an example of a computer system 800 that can form part of or implement any of the systems and/or devices described above. The computer system 800 can include a set of instructions 845 that the processor 805 can execute to cause the computer system 800 to perform any of the operations described above. An example of the computer system 800 can operate as a stand-alone device or can be connected, e.g., using a network, to other computer systems or peripheral devices.

In a networked example, the computer system 800 can operate in the capacity of a server or as a client computer in a server-client network environment, or as a peer computer system in a peer-to-peer (or distributed) environment. The computer system 800 can also be implemented as or incorporated into various devices, such as a personal computer or a mobile device, capable of executing instructions 845 (sequential or otherwise), causing a device to perform one or more actions. Further, each of the systems described can include a collection of subsystems that individually or jointly execute a set, or multiple sets, of instructions to perform one or more computer operations.

The computer system 800 can include one or more memory devices 810 communicatively coupled to a bus 820 for communicating information. In addition, code operable to cause the computer system to perform operations described above can be stored in the memory 810. The memory 810 can be random-access memory, read-only memory, programmable memory, hard disk drive, or any other type of memory or storage device.

The computer system 800 can include a display 830, such as a liquid crystal display (LCD), a cathode ray tube (CRT), or any other display suitable for conveying information. The display 830 can act as an interface for the user to see processing results produced by processor 805.

Additionally, the computer system 800 can include an input device 825, such as a keyboard or mouse or touchscreen, configured to allow a user to interact with components of system 800.

The computer system 800 can also include a disk or optical drive unit 815. The drive unit 815 can include a computer-readable medium 840 in which the instructions 845 can be stored. The instructions 845 can reside completely, or at least partially, within the memory 810 and/or within the processor 805 during execution by the computer system 800. The memory 810 and the processor 805 also can include computer-readable media as discussed above.

The computer system 800 can include a communication interface 835 to support communications via a network 850. The network 850 can include wired networks, wireless networks, or combinations thereof. The communication interface 835 can enable communications via any number of communication standards, such as 802.11, 802.12, 802.20, WiMAX, cellular telephone standards, or other communication standards.

Accordingly, methods and systems described herein can be realized in hardware, software, or a combination of hardware and software. The methods and systems can be realized in a centralized fashion in at least one computer system or in a distributed fashion where different elements are spread across interconnected computer systems. Any kind of computer system or other apparatus adapted for carrying out the methods described herein can be employed.

The methods and systems described herein can also be embedded in a computer program product, which includes all the features enabling the implementation of the operations described herein and which, when loaded in a computer system, can carry out these operations. Computer program as used herein refers to an expression, in a machine-executable language, code or notation, of a set of machine-executable instructions intended to cause a device to perform a particular function, either directly or after one or more of a) conversion of a first language, code, or notation to another language, code, or notation; and b) reproduction of a first language, code, or notation.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

1. A computer-implemented method comprising:
determining, by a computer, whether an image depicts an individual that corresponds to a particular contact associated with a specific social networking goal specified in a goals database;
responsive to determining that the individual corresponds to the particular contact, retrieving from a contacts database a preferred communication mode and a preferred communication device associated with the particular contact;
communicating, by the computer, a meeting request to the particular contact via the preferred communication device using the preferred communication mode;
receiving, by the computer and from the preferred communication device, an acceptance of the meeting request; and
adding, by the computer, a record associated with the meeting request to a schedule database.

2. The computer-implemented method according to claim 1, wherein the computer corresponds to a portable device that includes an imager, wherein the method further comprises:
receiving the image from the imager of the portable device.

3. The computer-implemented method according to claim 2, wherein the portable device includes a display, wherein the method further comprises:
depicting the image and an overlay on the display of the portable device to indicate a location within the image of the particular contact.

4. The computer-implemented method according to claim 3, wherein the method further comprises:
depicting identifying information associated with the particular contact on the display of the portable device.

5. The computer-implemented method according to claim 1, further comprising:
selecting, by the computer, one or more social networking goals from the goals database associated with a date range that overlaps a current date, wherein the specific social networking goal corresponds to one of the one or more social networking goals.

6. The computer-implemented method according to claim 1, further comprising:
determining, by the computer, a geographic location associated with the image;
selecting, by the computer, one or more social networking goals from the goals database associated with one or more locations in proximity to the geographic location, wherein the specific social networking goal corresponds to one of the one or more social networking goals.

7. The computer-implemented method according to claim 6, wherein the computer includes location circuitry configured to provide a geographic location of the computer, wherein determining the geographic location associated with the image comprises:
obtaining, by the computer, the geographic location from the location circuitry of the computer.

8. The computer-implemented method according to claim 1, further comprising:
responsive to communicating the meeting request to the particular contact, updating, by the computer, a record in the goals database associated with the specific social networking goal to indicate communication with the particular contact has been attempted.

9. The computer-implemented method according to claim 1, further comprising:
determining, by the computer, that the image depicts a plurality of individuals that correspond to a plurality of contacts associated with a plurality of social networking goals specified in the goals database, wherein the plurality of social networking goals specify a rank;
communicating, by the computer, a first meeting request to a first contact of the plurality of contacts associated with a first social networking goal having a highest rank via a preferred communication device and a preferred communication mode associated with the first contact; and
subsequent to receiving an acceptance of the first meeting request and the adding of a first record associated with the first meeting request to the schedule database, communicating, by the computer, a second meeting request to a second contact associated with a second social networking goal having a next highest rank via a preferred communication device and a preferred communication mode associated with the second contact.

10. The computer-implemented method according to claim 1, wherein communicating the meeting request to the preferred communication device comprises:
obtaining, by the computer, from the schedule database an available time slot; and
embedding, by the computer, information in the meeting request that defines the available time slot.

11. The computer-implemented method according to claim 1, wherein retrieving from the contacts database the preferred communication mode associated with the particular contact comprises:
communicating, by the computer and to the preferred communication device, a request for the preferred communication device to provide the preferred communication mode; and
receiving, by the computer and from the preferred communication device, the preferred communication mode.

12. A system comprising:
a memory that stores instruction code; and
a processor in communication with the memory, wherein the instruction code is executable by the processor to perform acts comprising:
determining whether an image depicts an individual that corresponds to a particular contact associated with a specific social networking goal specified in a goals database;
responsive to determining that the individual corresponds to the particular contact, retrieving from a contacts database a preferred communication mode and a preferred communication device associated with the particular contact;
communicating a meeting request to the particular contact via the preferred communication device using the preferred communication mode;
receiving from the preferred communication device, an acceptance of the meeting request; and
adding a record associated with the meeting request to a schedule database.

13. The system according to claim 12, further comprising:
an imager, wherein the instruction code is executable by the processor to perform acts comprising:
receiving the image from the imager.

14. The system according to claim 13, further comprising:
a display, wherein the instruction code is executable by the processor to perform acts comprising:
depicting the image and an overlay on the display to indicate a location within the image of the particular contact.

15. The system according to claim 14, wherein the instruction code is executable by the processor to perform acts comprising:
depicting identifying information associated with the particular contact on the display.

16. The system according to claim 12, wherein the instruction code is executable by the processor to perform acts comprising:
selecting one or more social networking goals from the goals database associated with a date range that overlaps a current date, wherein the specific social networking goal corresponds to one of the one or more social networking goals.

17. The system according to claim 12, wherein the instruction code is executable by the processor to perform acts comprising:
determining a geographic location associated with the image; and
selecting one or more social networking goals from the goals database associated with one or more locations in proximity to the geographic location, wherein the specific social networking goal corresponds to one of the one or more social networking goals.

18. A non-transitory computer-readable medium having stored thereon instruction code, wherein the instruction code is executable by a processor of a computer to perform acts comprising:
determining whether an image depicts an individual that corresponds to a particular contact associated with a specific social networking goal specified in a goals database;
responsive to determining that the individual corresponds to the particular contact, retrieving from a contacts database a preferred communication mode and a preferred communication device associated with the particular contact;
communicating a meeting request to the particular contact via the preferred communication device using the preferred communication mode;
receiving from the preferred communication device, an acceptance of the meeting request; and
adding a record associated with the meeting request to a schedule database.

19. The non-transitory computer-readable medium according to claim 18, wherein the instruction code is executable by the processor of the computer to perform acts comprising:
selecting one or more social networking goals from the goals database associated with a date range that overlaps a current date, wherein the specific social networking goal corresponds to one of the one or more social networking goals.

20. The non-transitory computer-readable medium according to claim 18, wherein the instruction code is executable by the processor of the computer to perform acts comprising:
determining a geographic location associated with the image;
selecting one or more social networking goals from the goals database associated with one or more locations in proximity to the geographic location, wherein the specific social networking goal corresponds to one of the one or more social networking goals.
